(19) United States
(12) Patent Application Publication
(10) Pub. No.: US 2008/0046943 A1
(43) Pub. Date: Feb. 21, 2008

(54) Internet adapter system and method for television

(76) Inventors: Nick Colsey, Del Mar, CA (US); Mark Allen Hanson, San Jose, CA (US); Jason R. Meerbergen, San Diego, CA (US); Lee Pedlow, Ramona, CA (US); Gen Tsuchikawa, San Diego, CA (US)

Correspondence Address: ROGITZ & ASSOCIATES, 750 B STREET, SUITE 3120, SAN DIEGO, CA, 92101, US

(21) Appl. No.: 11/803,989

(22) Filed: May 16, 2007

Related U.S. Application Data
(60) Provisional application No. 60/838,940, filed on Aug. 18, 2006.

(51) Int. Cl. H04N 7/16

(52) U.S. Cl. 725/110; 725/109

(57) ABSTRACT

A TV communicates with an Internet video system providing video content to the TV for display of the content on the TV. The Internet video system also provides information to the TV for rendering into a user interface (UI) screen on the TV and presenting icons representing respective Internet video providers, the icons being arranged on the screen in accordance with respective remunerations remitted by each provider. Parental controls entered into the V-chip of the TV can be automatically provided to the Internet video system for implementation in the Internet video system.

This application claims priority from U.S. provisional application 60/838,940, filed Aug. 18, 2006.

### I. FIELD OF THE INVENTION

The present invention relates generally to systems and methods for Internet adapters for TVs.

### II. BACKGROUND OF THE INVENTION

The fusion of television with the Internet is a continuing goal that has spawned systems making it convenient for viewers to access content from both conventional TV sources and the Internet using a single TV chassis. In this way, the number of programs that can be made available to people using the familiar technology of television can be expanded enormously.

As understood herein, it is desirable to tightly couple the TV viewing experience with Internet access through a TV. As further recognized herein, this critical observation can entail a number of envisioned features, and it is with these observations in mind that the invention herein is provided.

### SUMMARY OF THE INVENTION

A system includes a TV and an Internet video system providing video content to the TV for display of the content on the TV. The video system provides information to the TV for rendering into a user interface (UI) screen on the TV and presenting plural icons representing respective Internet video providers. The icons are arranged on the screen in accordance with respective remunerations remitted by each provider. If desired, the arrangement of icons presented on the screen can change when remuneration changes.

In some implementations a remote control is configured to send commands to the TV, and the TV forwards the commands to the Internet video system such that a user can navigate through the Internet video system by means of the TV and the remote control. In these implementations the Internet video system may include a server functioning as a gatekeeper to ensure incompatible Internet content is filtered out from view on the TV. If desired, the server can abstract uniform resource indicators (URI) of the Internet videos such that a user does not have to enter a URI using the remote control to cause an Internet video to be played on the TV.

In non-limiting embodiments a user can manipulate the remote control to enter a preference such as a content rating limit contained in a V-chip into the TV. The TV automatically provides the preference to the Internet video system for implementation thereof in the Internet video system.

In another aspect, a TV receives video content from an Internet video system. A user can manipulate a remote control that is configured to wirelessly send commands to the TV to enter a preference into the TV, with the TV automatically providing the preference to the Internet video system for implementation thereof in the Internet video system.

In still another aspect, an Internet video system provides video content to a TV for display of the content on the TV. A remote control that is configured to wirelessly send commands to the TV can be manipulated such that the TV forwards the commands to the Internet video system. With this feature a user can navigate through the Internet video system by means of the TV and the remote control.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system architecture in accordance with present principles;

FIG. 2 is a block diagram illustrating non-limiting data flow related to the net navigator portion of FIG. 1;

FIG. 3 is a flow chart of non-limiting logic that can be implemented as part of the present invention;

FIG. 4 is a non-limiting screen shot illustrating the outcome of the logic shown in FIG. 3; and

FIG. 5 is another non-limiting screen shot of a user interface for navigating the Internet video service.

### DETAILED DESCRIPTION OF THE PREFERRED EMBODIMENT

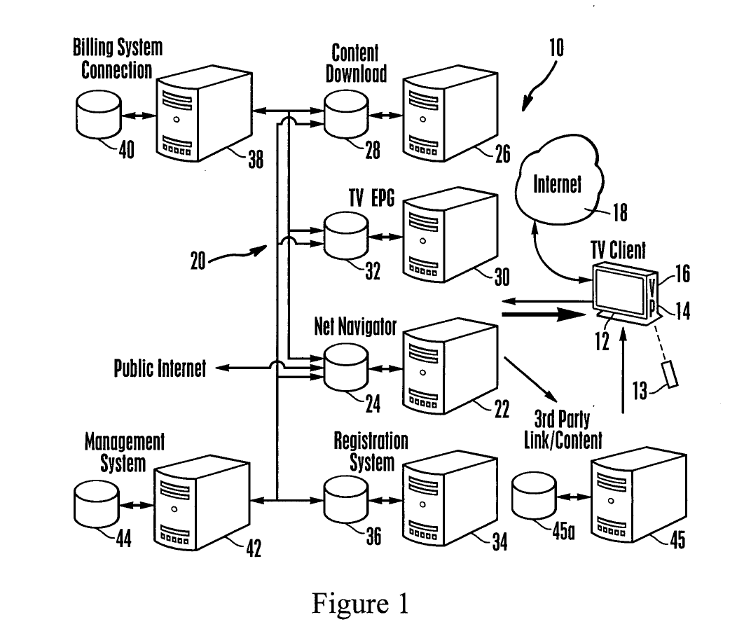

Referring initially to FIG. 1, a system is shown, generally designated 10, for providing Internet content to a television (TV) 12 having a TV remote control 13, TV processor 14 and, in some embodiments, a parental ratings chip 16 commonly referred to as a “V-chip.” The TV 12 may communicate directly with the Internet 18 as shown and may also communicate with an Internet video service system, generally designated 20, that can include one or more computers and one or more databases. It is to be understood that while FIG. 1 shows several computers and databases, each computer may be embodied as a module within a single physical computer, and/or each of the computer functions described below in relation to any single computer may be distributed across plural computers in specific implementations. Likewise, while plural databases are shown in FIG. 1, the Internet video service system 20 may include greater or fewer databases.

It is to be further understood that all or parts of the Internet video service system 20 may be implemented in an adapter housing that is local to the TV 12 and indeed that may be integrated within the housing of the TV 12. Or, all or parts of the Internet video service system 20 may be implemented remotely from the TV 12 outside the dwelling in which the TV 12 is located and accessible by the TV 12 through wired or wireless network connections.

With the above overview in mind, attention is directed to the Internet video service system 20 of FIG. 1, which includes a net navigator processor 22 with associated data storage 24 that may be implemented as disk storage or solid state storage or other type of storage. Details of the net navigator 22 are set forth further below. As indicated in FIG. 1, the net navigator 22 can access the Internet.

The Internet video service system 20 may further include the following non-limiting elements. A content download processor 26 with associated data store 28 may be provided to download and store audio-video content from the Internet. Also, a TV electronic program guide (EPG) processor 30 with associated data store 32 may be provided to establish all or parts of a TV EPG that can include broadcasting times for both TV programming as well as A/V content in the content data store 28. A registration processor 34 with associated data store 36 can be provided to facilitate user registration with the system 20 using registration principles known in the art. Also, a billing processor 38 with data store 40 can be provided for billing purposes, e.g., to bill users based on each piece of content accessed from the system 20, or based on time accessing the system 20, etc., and a management processor 42 with data store 44 can be provided to coordinate the activities of the above-discussed processors. As mentioned previously, all or some of the above functions may be undertaken by a single processor if desired.

Concluding the description of FIG. 1, a third party server 45 with associated third party data store 45a may be provided to communicate particular third party content to the TV 12 and system 20 as shown.

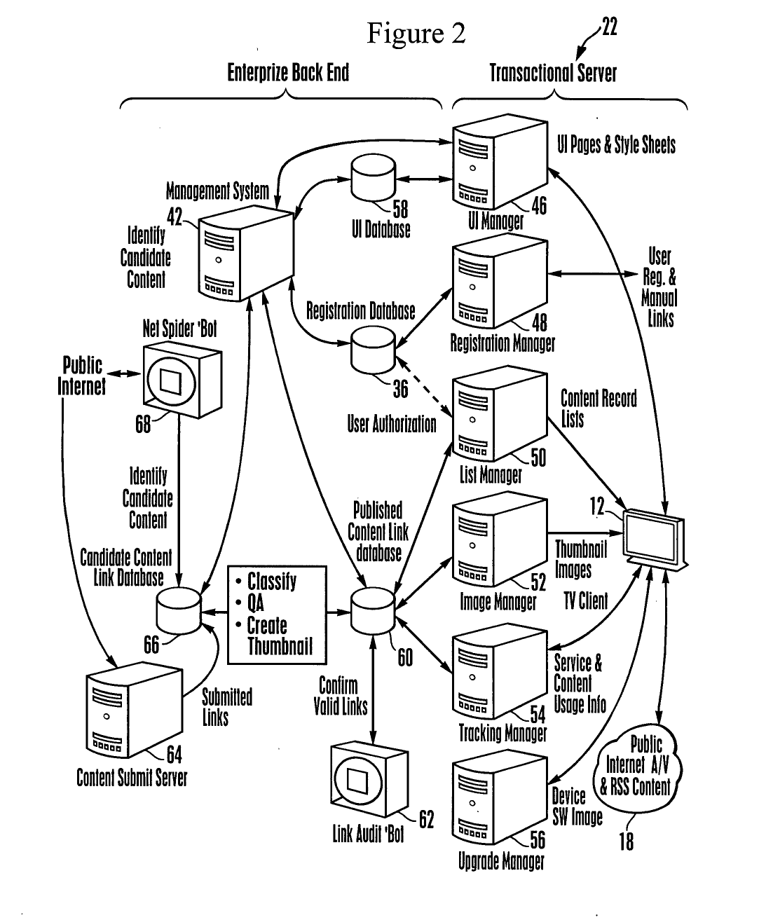

Now referring to FIG. 2, non-limiting details of the net navigator 22 are shown, in which six example modules of the net navigator 22 are referred to as a user interface (U/I) manager 46, a registration manager 48, a list manager 50, an image manager 52, a tracking manager 54, and an upgrade manager 56. As shown, the registration manager 48 communicates with the registration data store 36, which also communicates with the above-mentioned management processor 42.

The other managers 46, 50, 52, 54, 56 of the net navigator 22 may each communicate with the TV 12 as shown. Also, the U/I manager 46, which provides user interface pages and style sheets to the TV 12, may communicate with a U/I data store 58, which also communicates with the management processor 42. The list manager 50, image manager 52, and tracking manager 54 may each communicate with a published content link data store, which is accessed by a link audit bot 62 under control of a processor for confirming which links (e.g., a uniform resource identifier (URI)) in a link record data store 60 are valid links. Content from the Internet is downloaded to a content submission server or component 64 and links to the content are stored in a candidate content link data store 66, which is also accessed by a net spider bot 68 for purposes to be shortly disclosed.

With the above description of FIG. 2 in mind, the net navigator 22 searches for and identifies URI data for audio-video content that is publicly available on the Internet. The URI information is formatted into records, each of which contains metadata and a respective descriptive thumbnail representing and typically created from the underlying content. The records are stored in the link record data store 60 and each stored record can be sorted using multiple sort keys, the indices for which are also stored in the record contained in the link record database 60.

While not reflected in the logical drawing of FIG. 2, it is to be understood that each manager task depicted in the transactional server may actually be implemented in a single, consolidated server or instantiated in one or more individual servers having the same transactional context in order to allow modular, scalable capacity enhancement as the usage of the system grows. The IP connection to the composite transactional server can pass through a hardware-based load balancer that can segregate traffic to/from each category of manager tasks and distribute the transactions for each equitably amongst the servers for each category.

In essence, the net navigator may be conceptualized as being broken into two major operational elements, the six modules (“managers”) 46-56 and the enterprise backend shown at the left in FIG. 2. The modules or managers 46-56 may be implemented as Linux-Apache-PhP platforms in non-limiting embodiments.

The UI manager 46 can execute on an Apache-based web server application handling incoming requests from TV clients. The purpose of the UI manager 46 is to deliver user interface templates that make up the look and feel of the Internet video provision product on the TV 12, such as the example screen shots shown in FIGS. 4 and 5. The UI content can be service specific. When a user selects a service offering from a TV cross-media bar (XMB) menu that may not be hosted by the system 20 provider, e.g., that might be hosted by the third party server 45 in FIG. 1, the TV 12 client navigates to the server hosting that service offering and the interface presented on the TV can be that of the presenting service.

In contrast, if the service 20 is selected, the UI manager 46 is accessed and in response, a combination of HTML, CSS and ECMAscrlpt (Javascript) payloads are delivered to the client. Execution of the scripts delivered by the UI manager 46 can result in the rendering of a user interface (“UI”, described further below) and the accessing of the content list manager 50 and image manager 52 to populate the UI with images of the A/V content that is available. The TV may query in hypertext transfer protocol (HTTP) and the manager 46 may respond in extensible markup language (XML).

The registration manager 48, which may be embodied by the registration processor 34 shown in FIG. 1, provides a public window for the data services infrastructure, allowing users to register devices such as TVs and if further desired methods to customize the look and feel of their products. The registration manager 48 may be executed on an Apache-based web server implementation that interacts with the registration database 36. For registration purposes, communication may be in HTTP.

The list manager 50 can execute on an Apache-based web server handling incoming queries from the TV 12 for link record lists. The list manager 50 may execute a PhP script engine to create SQL queries to the link record database 60 and to format returned data for transmission to the TV 12 through the Apache web server. The TV may query in hypertext transfer protocol (HTTP) and the manager 50 may respond in extensible markup language (XML).

The image manager 52 may execute on an Apache-based web server handling incoming queries from the TV 12 for thumbnail images. The image manager 52 may execute a PhP script engine to create SQL queries to the link record database 60 for image retrieval and to format returned images for transmission to the TV 12 through the Apache web server. The TV may query in hypertext transfer protocol (HTTP) and the manager 50 may respond in extensible markup language (XML) and JPEG.

The tracking manager 54 provides a method for logging client usage of a service of access to a particular A/V content. Its purpose is to collect usage statistics for gauging content/service popularity, billing or other business processes. The TV may query in hypertext transfer protocol (HTTP) and the manager 54 may respond in HTTP.

When a client makes a request for a content link record, the record returned can include a URI for the target link. The listed URI can be a proxy URI which, when subsequently accessed, provides a redirect of the client to the real URI for the link. When the proxy URI is accessed, the manager script increments the usage count associated with the content or service. This allows usage tracking, billing, etc. in real time without resorting to cumbersome tracking methods such as client polling, etc.

Preferably, the target URI points to the tracking manager 54. The tracking manager 54, upon receiving the request, parses the request string to recover the actual service URI data contained within the parameter string of the request. The service URI can be obscured if desired when created and hosted by imposing the simple Caesar cipher known as “ROT13”, in which each alphabetic character in a string is replaced by the letter that is thirteen places further along in the alphabet, wrapping back to the beginning if necessary, preserving case. Numbers, symbols, whitespace, and all other characters may be left unchanged. Thus, the tracking manager 54 of the Internet video service system 20 acts as a gatekeeper between the TV 12 and the video provider to ensure incompatible content is filtered out and to abstract the URI of each video so the user does not have to enter long alphanumeric URIs.

The upgrade manager 56 provides two functions. The first function is to provide information regarding the current software version in response to queries by the TV 12. The second function is to host software images for download to the TV 12 upon request. The update manager 56 can execute on an Apache-based web server handling incoming queries from the TV 12 in HTTP for software version information that may be returned in XML.

Turning now to the various back end elements, the UI database 58 may be, without limitation, a “MySQL” database containing the HTML, CSS and ECMAscrlpt (Javascript) elements comprising various UI templates. The link database 60, on the other hand, contains all information regarding available A/V content or service aggregators. It may be implemented as a MySQL database. The two main data types accessible through client interaction are content link records and image thumbnails. Both data types can be used to describe specific A/V opportunities or external content aggregation services that may be promoted to the TV 12. Each data type can be accessed through a separate manager but held in a single common database. The images in the image manager 52 may be one-way indexed through a URI pointer field contained in the link record, and there need be no reverse linkage from an image to a content link record. In this way, one image may be multiply referenced by an arbitrary group of content link records, allowing flexibility and storage savings. An example for such a record might be a “not available” icon or “adult content” icon that would be chosen for use on certain content records in lieu of an actual Image from the content itself.

In non-limiting implementations each data record may contain the following fields.

Thumbnail PEG still image

Content Genre

Content Location URI

Content Type

Content Video Format

Content Audio Format

Content Title

Content Description

Content Rating

Popularity Index

Addition Date

Content Duration

Content Description (Short)

Content Description (Long)

Content Thumbnail URI (Points to image manager 52 location)

Content URI

Rating

Genre

Content Duration

Addition Date

Popularity Index

Content Type

Content Video Codec

Content Video Format

Content Video Bitrate

Video Interlace (Yes/No)

Video Frame Rate

Video Bit Rate

Content Audio Codec

Content Audio Format

Content Audio Bit Rate

A/V Synchronized Content Flag

Last audit timestamp

Viewable flag

Service flag

Turning to the candidate content links database 66, this database architecturally may be a mirror to the published content links database 60, but the purpose of the candidate content links database 66 is to act as an intermediate repository of content information that is identified, manually submitted, etc. and pending approval to be published as part of the service offering. The candidate content links database 66 also serves as a workplace to hold links while thumbnails (or other icons) are added, descriptions are created, etc. as part of the content link workflow.

The management system 42 may embody a MySQL database and manager that allows remote management of the entire infrastructure, collects usage information, monitors system health and throughput. It may generate reports based upon the collected statistics stored In the database.

The net spider 'bot (NSB) 68 can be an autonomous entity that continuously scans the world wide web looking for instances of publicly available A/V content meeting predefined criteria for stream format, codec type, duration, video format, etc. This process may include tunneling through the HTML source code to find embedded links to A/V content. When a potential match is found, the NSB 68 may create a new entry in the candidate content link database 66 and can populate the fields with the information it can determine. Some of this information may be contextual, such as adult terms used on the hosting page may default the rating to “adult”. The NSB 68 may further report the find to the management system 42 for review.

The link bot 62, when implemented, can be used to identify content owners and email them a link to a form requesting permission to host the content and soliciting information regarding genre, rating, title, description, etc. If the respondent grants permission, the page is reviewed and added to the published content link database 60. The publishing process can be completed upon the physical transfer of a record in the candidate content link database 66 to the published content link database 60.

Individuals, notified through advertising, promotions or word of mouth, can directly access the content submit server 64 to grant permission to content links they volunteer. They provide the location and other metadata, submit the thumbnail, etc. Links obtained in this manner can also be put into a pending state on the candidate content link server for the same review and approval process as content sifted by the NSB 68.

The link audit 'bot (LAB) 62 is an autonomous entity that periodically reviews the contents of the published content link database 60 to confirm that the content is still valid and available. The LAB 62, to reduce loading of the production managers, can directly interpret the URI for content location and extract/convert the ROT13 encoded return URI to ASCII clear text and then directly access the hosting site/manager without using the tracking manager 54. The LAB 62 can generate reports of published content/links that are unavailable and the information provided by the hosting manager when the unavailable determination was reached. The results may be provided to the management system 42 for human intervention and as necessary, delisting of expired content.

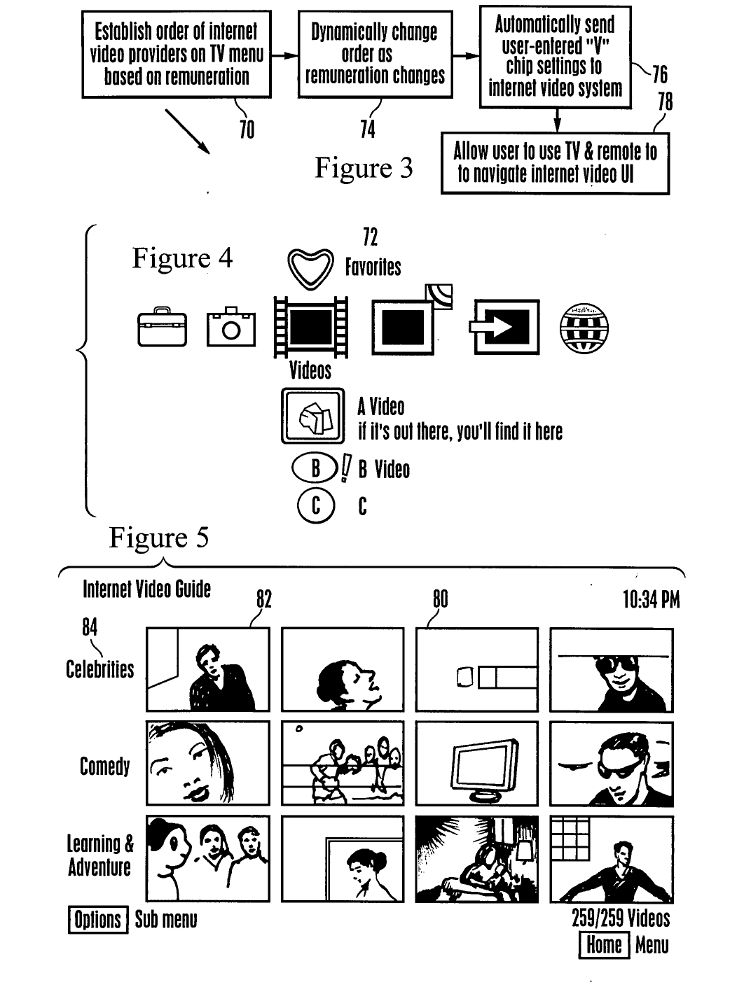

Now referring to FIG. 3, various logic undertaken by the system shown in FIGS. 1 and 2 can be appreciated. Commencing at block 70, the order on an Internet video UI provided by the system 20 and provided to the TV 12 for display thereof is established based on the remuneration paid by the various Internet video providers to the entity or entities associated with the system 20. Specifically, video providers are placed higher in the TV menu based on how much they pay.

Thus, in the non-limiting XMB menu example shown in FIG. 4, an icon 72 of a video provider “A” is placed at the top of a list of Internet video providers because provider “A” remitted the highest remuneration. Second highest on the list is video provider “B” as shown, then provider “C”, indicating that provider “B” remunerated less than provider “A” and that provider “C” remunerated less than provider “B”. By clicking on the icon 72 using the remote 13, the viewer will be presented with a secondary screen showing videos available from the provider “A”, such as the screen shown in FIG. 5 and discussed further below. At block 74, the order of providers can dynamically change as remuneration figures change, even hourly.

Proceeding to block 76 in FIG. 3, preferences such as ratings screens that are stored on the TV 12, e.g., parental ratings set by a user in the V-chip 16 are automatically sent to the internet video system 20 to form a seamless user experience, avoiding duplicate set-up. In this way and recalling that the bot 68 associates ratings with Internet videos it places into the candidate database 66, the system 20 will only make available to the TV 12 Internet videos conforming to the ratings in the TV's V-chip 16 by, e.g., making available in the link database 60 only those candidates in the database 66 that meet the ratings limitations.

Further and as mentioned above, in some implementations the user is permitted to navigate the Internet video service 20 using the remote control 13. The remote control 13 sends wireless commands to the TV 12, and the TV processor 14 interprets the commands and forwards the commands to the Internet video service system 20 so that the user can navigate URIs and other functions to cause Internet videos to be played on the TV 12.

Indeed and referring to FIG. 5, a secondary UI screen 80 is shown that has been invoked and displayed on the TV 12 when the user selected the Internet video provider “A” from the top level UI of FIG. 4. As shown, the secondary UI screen 80 contains thumbnails (or other icons) 82 representing underlying video streams. In the example shown the thumbnail 82 in the upper left part of the display has been selected by the user by positioning a screen cursor over the thumbnail using the remote control 13. The screen 80 near the bottom indicates that the title of the underlying video of the selected thumbnail is “confession”, and it also indicates when the video first aired, and its rating. The thumbnails advantageously are grouped by genre as shown, with a genre label 84 being displayed to the left of each row and with each row representing a respective genre. With the cursor highlighting a thumbnail, the user can enter “select” on the remote control 13 and the TV 12 relays the command to the Internet video system 20 to prompt the system 20 to provide the underlying video to the TV 12 for display thereof on the TV.

While the particular INTERNET ADAPTER SYSTEM AND METHOD FOR TELEVISION is herein shown and described in detail, it is to be understood that the subject matter which is encompassed by the present invention is limited only by the claims.

What is claimed is:

1. A system, comprising:
at least one TV;
at least one Internet video system providing video content to the TV for display of the content on the TV, the video system providing information to the TV for rendering into a user interface (UI) screen on the TV and presenting plural icons representing respective Internet video providers, the icons being arranged on the screen in accordance with respective remunerations remitted by each provider.

2. The system of claim 1, wherein the arrangement of icons presented on the screen changes at least some of the time when remuneration changes.

3. The system of claim 1, comprising a remote control configured to send commands to the TV, the TV forwarding the commands to the Internet video system such that a user can navigate through the Internet video system by means of the TV and the remote control.

4. The system of claim 3, wherein the Internet video system includes at least one server functioning as a gatekeeper to ensure incompatible Internet content is filtered out from view on the TV.

5. The system of claim 4, wherein the server abstracts a uniform resource indicator (URI) of at least some Internet videos such that a user does not have to enter a URI using the remote control to cause an Internet video to be played on the TV.

6. The system of claim 1, wherein a user can manipulate a remote control to enter at least one preference into the TV, the TV automatically providing the preference to the Internet video system for implementation thereof in the Internet video system.

7. The system of claim 6, wherein the preference is a content rating entered into a V-chip of the TV.

8. A system, comprising:
at least one TV;
at least one Internet video system providing video content to the TV for display of the content on the TV; and
at least one remote control configured to wirelessly send commands to the TV, wherein a user can manipulate the remote control to enter at least one preference into the TV, the TV automatically providing the preference to the Internet video system for implementation thereof in the Internet video system.

9. The system of claim 8, wherein the preference is a content rating entered into a V-chip of the TV.

10. The system of claim 8, wherein the video system provides information to the TV for rendering into a user interface (UI) screen on the TV displaying icons representing plural Internet video providers, the icons being arranged on the screen in accordance with respective remunerations remitted by each provider.

11. The system of claim 10, wherein the arrangement of icons presented on the screen changes at least some of the time when remuneration changes.

12. The system of claim 8, wherein the TV forwards at least some commands from the remote control to the Internet video system such that a user can navigate through the Internet video system by means of the TV and the remote control.

13. The system of claim 12, wherein the Internet video system includes at least one server functioning as a gatekeeper to ensure incompatible Internet content is filtered out from view on the TV.

14. The system of claim 13, wherein the server abstracts a uniform resource indicator (URI) of at least some Internet videos such that a user does not have to enter a URI using the remote control to cause an Internet video to be played on the TV.

15. A system, comprising:
at least one TV;
at least one Internet video system providing video content to the TV for display of the content on the TV; and
at least one remote control configured to wirelessly send commands to the TV, the TV forwarding the commands to the Internet video system such that a user can navigate through the Internet video system by means of the TV and the remote control.

16. The system of claim 15, wherein the Internet video system includes at least one server functioning as a gatekeeper to ensure incompatible Internet content is filtered out from view on the TV.

17. The system of claim 16, wherein the server abstracts a uniform resource indicator (URI) of at least some Internet videos such that a user does not have to enter a URI using the remote control to cause an Internet video to be played on the TV.

18. The system of claim 15, wherein the video system provides information to the TV for rendering into a user interface (UI) screen on the TV and presenting plural icons representing respective Internet video providers, the icons being arranged on the screen in accordance with respective remunerations remitted by each provider.

19. The system of claim 17, wherein the arrangement of icons presented on the screen changes at least some of the time when remuneration changes.

20. The system of claim 15, wherein a user can manipulate the remote control to enter at least one preference into the TV, the TV automatically providing the preference to the Internet video system for implementation thereof in the Internet video system.
